(19) United States
(12) Patent Application Publication
(10) Pub. No.: US 2003/0151510 A1
(43) Pub. Date: Aug. 14, 2003

(54) Camera security system and methods associated therewith

(76) Inventors: Angelica Quintana, Fort Collins, CO (US); Theodore B. Ziemkowski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/071,716

(22) Filed: Feb. 8, 2002

(51) Int. Cl. G08B 13/12

(52) U.S. Cl. 340/568.2

(57) ABSTRACT

Disclosed herein are various embodiments of a camera and methods associated therewith for notifying a user upon separation of the camera from a parent object.

### BACKGROUND

Cameras are compact and expensive and therefore occasionally misplaced or targeted for theft. During highly photographed activates such as sightseeing, recreating and traveling, thieves often steal cameras. Thieves may take advantage of a preoccupied camera user who often looses focus on the whereabouts of the camera. This preoccupation may lead to a theft opportunity or misplacement.

Cameras are provided with a variety of features and functions. These features and functions are provided and/or controlled by electrical devices such as a controller. Elements of a camera that are commonly associated with its controller include buttons, switches, power sources, speakers, displays, strobes and a variety of other elements.

### SUMMARY

In one embodiment disclosed herein, a camera security system may include: a camera housing; a receptacle formed in said camera housing; and a strap electrically associated with said receptacle.

In another embodiment disclosed herein, a method of securing a camera may include: capturing, at least partially, a parent object with a strap; connecting said to said camera; and invoking a security mode provided with said camera.

In another embodiment disclosed herein, a method of manufacturing a camera may include: providing a camera housing; providing a microprocessor within said camera housing; and associating, operatively, a security system algorithm with said microprocessor.

### BRIEF DESCRIPTION OF THE DRAWINGS

Illustrative and presently preferred embodiments are illustrated in the drawings in which:

FIG. 1 shows a perspective view of a camera having security system.

FIG. 2 shows a rear elevation view of a camera having a security system provided therewith.

FIG. 3 shows a top plan view of a strap.

FIG. 4 shows a block diagram of a camera security system algorithm.

FIG. 5 shows a rear elevation view of a camera having a recoilable strap provided therewith.

FIG. 6 shows a top elevation view of a strap having two connectors.

### DETAILED DESCRIPTION

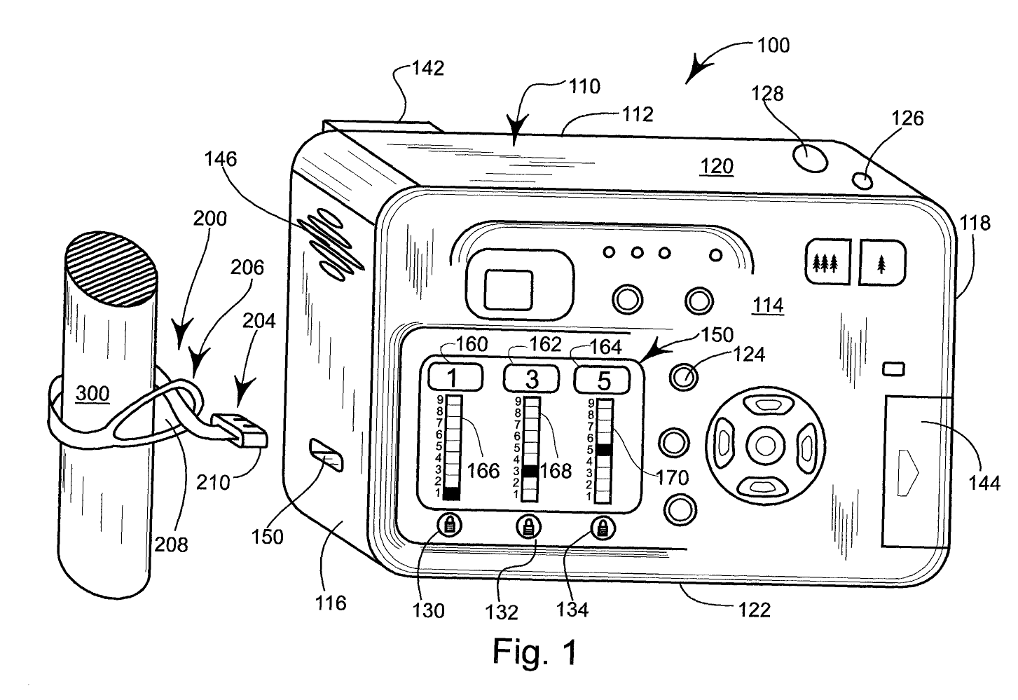

FIG. 1 shows a digital camera 100 having a security system provided therewith. The security system may be utilized to notify a user upon occurrence of separation between a parent object 300 and the camera 100. As part of this security system, the camera 100 may be provided with a housing 110 and a strap 200. Housing 110 may have a front 112, a back 114, a left side 116, a right side 118, a top 120 and a bottom 122. The camera 100 may be provided with a plurality of user interfaces such as a button 124, a power button 126, a capture button 128, a first combination button 130, a second combination button 132 and a third combination button 134 for operating the camera 100 and features associated therewith.

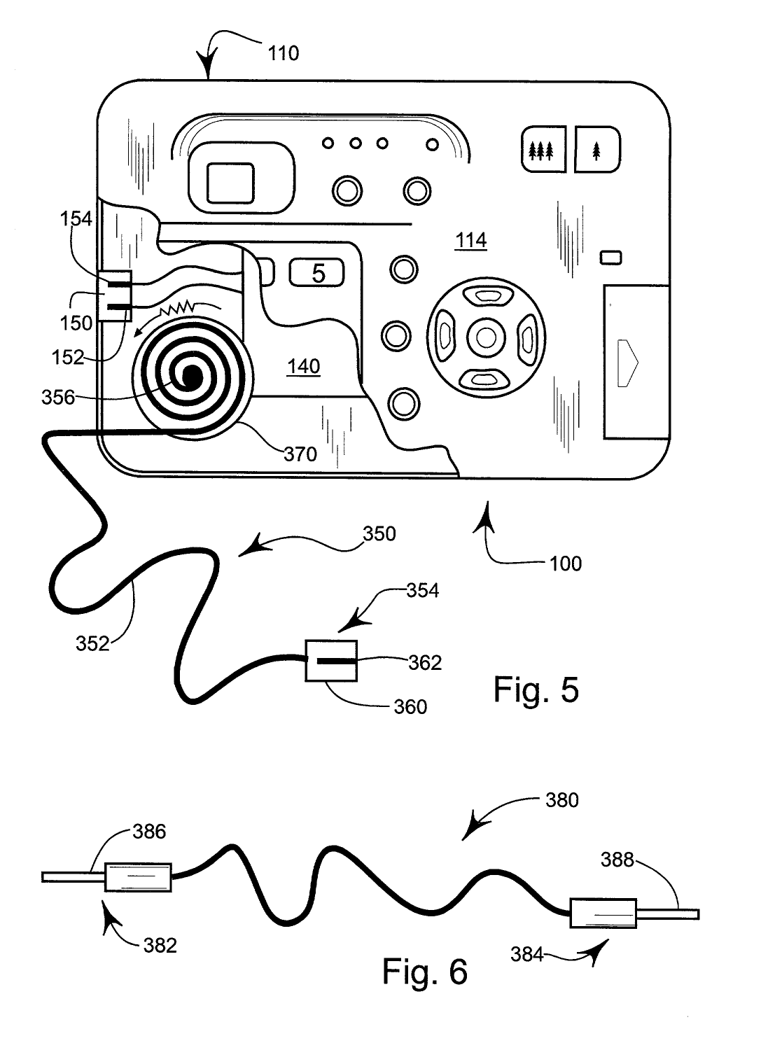

The camera 100 may be provided with a lens assembly (not shown), a controller 140 (FIG. 5) and a photosensor array (not shown). The photosensor array may, for example, be one or more two-dimensional arrays. As used herein ‘photosensor array’ refers to both single array and multiple array type photosensor assemblies. The camera 100 may be further provided with other components such as a flash 142, a power supply (not shown), a storage media interface 144, a speaker 146 and at least one receptacle such as receptacle 150.

The lens assembly may be mounted to the camera housing front 112 in optical communication with the photosensor array. Light passing through the lens assembly forms an image of an object on the photosensor array. The photosensor array may be utilized in conjunction with the controller 140 in a process to form image data representative of the image of the object formed thereon in a manner well known in the art.

The photosensor array and other components such as the flash 142, the power supply, the storage media interface 144, the speaker 146 and the receptacle 150 may be placed in electronic communication with the controller 140 by conventional electronic interfaces such as conductor wires, circuit boards, etc. Furthermore, as shown in FIG. 5, the receptacle 150 may have a first conductor 152 and a second conductor 154 that are in electrical communication with the security system.

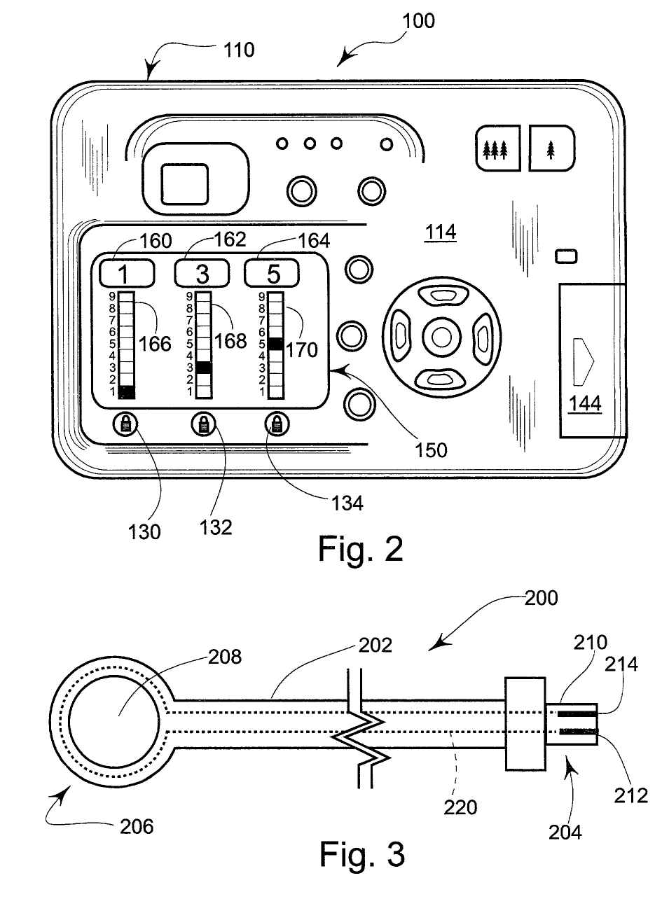

With reference to FIG. 2, the camera 100 may be further provided with a display 150. In one embodiment the digital camera 100 may be provided with a display 150 mounted on the camera back 114. However, it is to be understood that in other digital camera embodiments the display may be mounted on any of the other portions (e.g., 112, 116, 118, 120, 122) of the camera housing 110 or may even be detachable from and independently positionable relative to the housing 110 while remaining functionally connected to other components in the housing 110 as by wires, electromagnetic transmission, etc. The display 150 may be any of a variety of shapes, however commonly the shape is generally rectangular. The display 150 may be of any type including but not limited to display types now known in the art, such as a liquid crystal display (LCD), cathode ray tube display (CRT), light emitting diode display (LED), ferro-electric display, plasma display, etc. Image data of light reflected from an object is displayed on the display 150; furthermore, the display may show information utilized to manipulate various features provided with the camera 100 such as a camera security system.

In one exemplary, non-limiting embodiment shown in FIG. 2, the camera 100 having a camera security system may be further provided with a lock algorithm. Information pertinent to activating, setting, deactivating, or otherwise manipulating the lock algorithm may be shown on the display 150. As shown in FIG. 2, the lock algorithm may be provided with a first combination digit 160, a second combination digit 162 and a third combination digit 164. Furthermore, the digits 160, 162 and 164 may have bar-graph indicia associated therewith for providing indication of relationships between the combination buttons (e.g. 130, 132, 134) and the combination digits (e.g. 160, 162, 164). First combination digit 160 may have a first bar-graph 166 associated therewith. Second combination digit 162 may have a second bar-graph 168 associated therewith. Third combination digit 164 may have a third bar-graph 170 associated therewith.

With reference to FIG. 3, the strap 200 may be provided with a tether 202. The tether 202 may define a first distal portion 204 and an oppositely disposed second distal portion 206. The first distal portion 204 may be provided with a connector 210. The second distal portion 206 may be provided with an eyelet 208 formed therewith. The connector 210 may include a first conductor 212 and a second conductor 214. The strap 200 may further include a wire 220 imbedded therein and in electrical communication with the first and second conductors 212, 214. The wire 220, if provided, may be utilized for sensing if the strap 200 has been cut, severed or otherwise compromised. Such tampering with the strap 200 may inhibit or otherwise alter flow of current between the first conductor 212 and the second conductor 214.

Instructions pertinent to controlling the security system may be provided by the lock algorithm or, alternatively, by the camera security system. In one exemplary, non-limiting embodiment the controller 140 may be provided with firmware that is programmed onto and in controllable relationship with elements of the camera 100 (e.g. speaker 146, mode button 124, combination buttons 130, 132 and 134, receptacle 150, strap 200, etc.).

With reference to FIG. 1, the operation of a security system for a camera will now be detailed. The camera 100 having the security system is temporarily attached to a parent object 300. The parent object 300 may be any object which is less likely to be misplaced or stolen in comparison to the camera 100. Examples of the parent object 300 include a child stroller, a handle on a piece of luggage, a zipper pull on a jacket, a belt loop on a pair of pants, a handle on a drawer, or other objects as those skilled in the art can appreciate upon reading the present disclosure.

A user may be in an environment which is conducive to photography such as a park and desire to ensure that the camera 100 does not become misplaced, stolen, or otherwise lost. Therefore, the user may implement the camera security system to help maintain presence of the camera 100. At the outset, the user may wrap the strap 200 around a portion of the parent object 300. After wrapping the strap around the parent object 300, the first distal portion 204 may be introduced into and translated through the eyelet 208. With this configuration, the strap 200 is substantially attached to the parent object 300. Pulling on the first distal portion 204 serves to tighten the grip of the strap 200 on the parent object 300.

The connector 210 may be inserted into the receptacle 150 in another step. This insertion of the connector 210 into the receptacle 150 is not a permanent connection, but rather a temporary, readily removable connection. The connection of the strap 200 to the camera 100 places the first conductor 212 and the second conductor 214 into electrical communication with the camera 100 (e.g. the conductors 212 and 214 may be in electrical communication with the camera security system, lock algorithm, controller 140, or other systems provided with the camera 100).

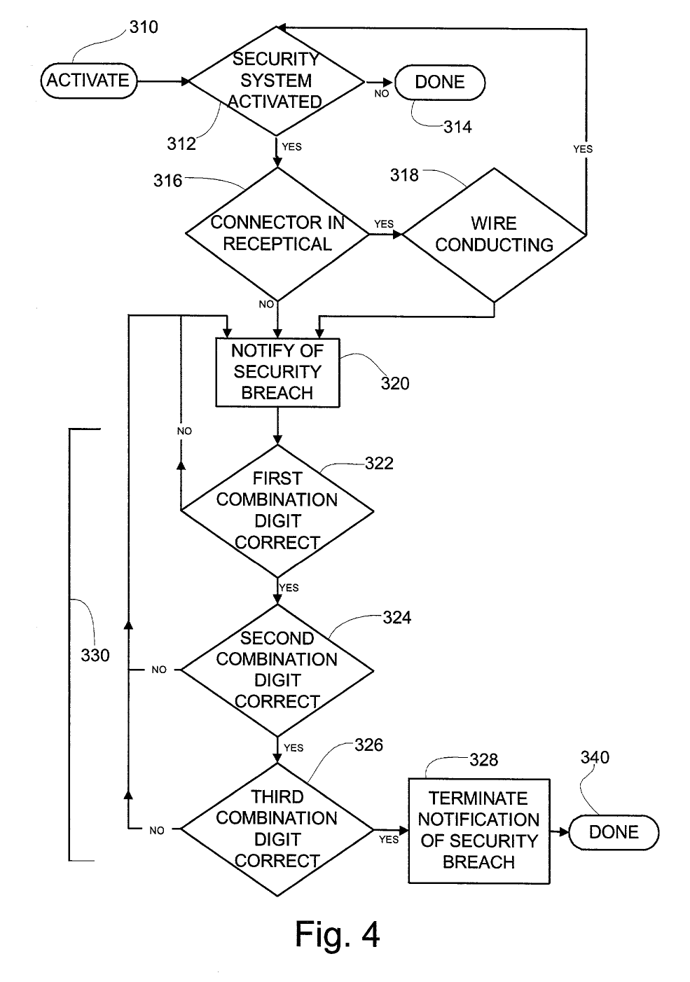

Having temporarily attached the camera 100 to the parent object 300 via the strap 200, the security system may be activated. With reference to FIG. 4, the activation 310 of the security system may determine that the connector 210 of the strap 200 has been inserted into the receptacle 150. Next, the security mode activated decision 312 may be provided. The security mode may be activated in any one of a variety of ways, such as by depressing the mode button 124. If the security system is not properly activated, the outcome of the security system activated decision 312 is negative and the process is done 314. However, if the security system is activated, the outcome of decision 312 is positive and a connector in receptacle decision 316 may commence.

If the connector 210 is in the receptacle 150, the outcome of decision 316 is positive and a wire conducting decision 318 may commence. During the wire conducting decision 318, the security system determines if the wire 220 remains un-tampered. If the strap 200 has not been tampered with, as evidenced by conduction within the wire 200, the outcome of the wire conducting decision 318 is positive. With a positive outcome from decision 318, the security system is activated and has not been compromised, therefore the security system activated decision 312 may be reinitiated.

In the event that the outcome of either the connector in receptacle decision 316 or wire conducting decision 318 is negative, a notification of security breach process 320 may commence. The notification of security breach process 320 may include any of a number of actions such as sounding of an alarm via the speaker 146, flashing of the strobe 142, capturing image data, or other actions as those skilled in the art will appreciate upon reading the present disclosure. One particularly effective notification is the sounding of an alarm of at least 100 decibels from the speaker 146. This notification of security breach process 320 serves to notify the user that the camera 100 has been separated from the parent object 300. Such separation may be intentional (such as taking a photograph) or unintentional (such as theft of the camera 100 or inadvertent misplacement). In either case, the user has been notified of this separation of the camera 100 and the parent object 300. The notification of security breach 320 may continue for a predetermined period of time, or alternatively may continue as long as the camera power supply allows.

Once the user desires to terminate the notification of security breach process 320, a lock algorithm 330 may be utilized to acknowledge this security breach and deactivate the alarm. It is noted that the lock algorithm 300 may be as simple as pushing the mode button 124, or alternatively more complicated such as entering a lock combination. In the event that the lock algorithm 300 requires the lock combination to be entered in order to acknowledge and terminate the notification, individual digits of the lock combination may be entered. The first combination digit 160 may be entered by pushing the first combination button 130. As the first combination button 130 is depressed, the first bar-graph 166 indicates the progressive nature of selecting the combination (e.g. digit “1” shown in the first combination digit 160 indicia). Once the user properly enters the first combination digit 160, a first combination digit correct decision 322 is satisfied.

Once the first combination digit correct decision 322 is positive, the second combination digit 162 may be entered by pushing the second combination button 132. As the second combination button 132 is depressed, the second bar-graph 168 indicates the progressive nature of selecting the combination (e.g. digit “3” shown in the second combination digit 162 indicia). Once the user properly enters the second combination digit 162, a second combination digit correct decision 324 is satisfied.

Once the second combination digit correct decision 324 is positive, the third combination digit 164 may be entered by pushing the third combination button 134. As the third combination button 134 is depressed, the third bar-graph 170 indicates the progressive nature of selecting the combination (e.g. digit “5” shown in the third combination digit 162 indicia). Once the user properly enters the third combination digit 164, a third combination digit correct decision 326 is satisfied.

In the event that any of the combination digit correct decisions 322, 324 and 326 are negative, the notify of security breach process 320 remains invoked. On the other hand, once the third combination digit correct decision 326 is positive, a terminate notification of security breach process 328 may commence. During the terminate notification of security breach process 328, the notification initiated by the notify of security breach process 320 is terminated. After the terminate notification of security breach process 328, the security system is complete 340.

With further reference to FIG. 4, it is noted that a user may deactivate the camera security system at any time during normal operation. This deactivation may occur in any one of a variety of ways. One method for deactivating the security system can be the utilization of the lock algorithm 330. It is noted that the lock algorithm 300 may be as simple as pushing the mode button 124, or alternatively more complicated such as entering a lock combination. In the event that the lock algorithm 300 requires the lock combination to be entered in order to deactivate the system, individual digits of the lock combination may be entered in a manner previously described.

Various alternative embodiments have been contemplated such as a recoilable strap 350 shown in FIG. 5. With reference to FIG. 5, the recoilable strap 350 may have a tether 352. The tether 352 may define a first distal portion 354 and an oppositely disposed second distal portion 356. The first distal portion 354 may be provided with a connector 360 having a conductor 362. The tether 352 may have a wire (not shown) provided therein for conducting electricity from the conductor 362 of the first distal portion 354 to the second distal portion 356. The second distal portion may be electrically interfaced with the security system (e.g. interfaced with the controller 140). Additionally, the recoilable strap 350 may be provided with a torsionally biased spool 370. The torsionally biased spool 370 may be configured such that it retracts and stores the tether 352 within the camera housing 110. When utilizing this alternative embodiment, the user pulls the first distal end from the camera housing 110 until a sufficient amount of the strap tether 352 is unwound from the torsionally biased spool 370. After wrapping the tether 352 around a parent object 300 (FIG. 1), the connector 360 may be inserted into the receptacle 150. As those skilled in the art will appreciate upon reading the present disclosure, implementation of this alternative embodiment is substantially similar to the implementation of the previously described embodiment.

In another alternative embodiment shown in FIG. 6, a strap 380 may be provided with two connectors. The strap 380 may define a first distal portion 382 and an oppositely disposed second distal portion 384. A first connector 386 may be provided on the first distal portion 382 and a second connector 388 may be provided on the second distal portion 384. The strap 380 may be further provided with a wire therein that may electrically connect the first connector 386 to the second connector 388. With this alternative embodiment, the first and second connectors 386, 388 are received by two receptacles (not shown) formed in the camera housing 110. These two receptacles may be substantially similar to receptacle 150. In one exemplary embodiment, the first connector 386 may, for example, be an audio jack connector and the second connector 384 may, for example, be a USB connector. Disruption of at least one of the connections between the strap 380 and the camera 100, or tampering with the wire may cause invoking of the camera security system in a substantially similar manner as previously described.

In yet another alternative embodiment not shown, the strap 200 may be provided without the wire 220. Therefore, the notification of security breach process 320 is invoked by disconnection of the connector 210 from the receptacle 150. However, actions that tamper with the strap 200, such as cutting, will not invoke the notification of security breach.

In yet another alternative embodiment, the notification of security breach process 320 shown in FIG. 4 may include a delay function. This delay function may delay the notification of the security breach for a predetermined period of time. This predetermined period of time delay will allow enough time for a user to temporarily disconnect the camera 100 from the strap 200 to take a photograph. Provided that the duration of time expended while taking the photograph is less than the predetermined delay, the camera 100 may be returned to the strap 200 and connection reestablished before the notify of security breach process 320 commences. By way of a non-limiting example, the action of disconnecting the camera 100 from the strap 200, taking a photograph and returning the camera to the strap 200 may, for example, take 15 seconds or less. Therefore, the predetermined delay provided with the notify of security breach process 320 may be, for example, 20 seconds. With this alternative embodiment, the user may be able to keep the security system in an activated state and temporarily photograph an object without deactivating the security system.

In another alternative embodiment, the lock algorithm 330 may be replaced with any one of a variety of predetermined activities for deactivating the notification of security breach process 320 (FIG. 4). Such activities may be uniquely programmed by the user, or alternatively preprogrammed into the camera 100. One such activity may be pressing the capture button 128 for a period of three seconds. Such activity would terminate the notify of security breach process 320.

The present disclosure provides a feature that decreases the likelihood of camera theft or misplacement. Cameras provided with the present security system may be manufactured in a cost effective manner and increase value to consumers.

It is noted that the previous description is directed towards a digital still camera, however this system could be used with other portable cameras such as digital video cameras, film video cameras, film still cameras or other devices providing similar functions. Accordingly, the term ‘camera’ as used herein means any type of camera capable of capturing image data.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

We claim:

1. A camera security system comprising:
a camera housing;
a receptacle formed in said camera housing; and
a strap electrically interfaced with said receptacle.

2. The camera security system of claim 1 and further comprising:
a photodetector array disposed within said camera housing.

3. The camera security system of claim 1 wherein said strap comprises:
a connector comprising at least one conductor.

4. The camera security system of claim 1 wherein an eyelet is formed in said strap.

5. The camera security system of claim 1 and further comprising:
a microprocessor disposed within said camera housing; and
wherein said strap is in electrical communication with said microprocessor.

6. The camera security system of claim 3 wherein said connector is a universal serial bus connector.

7. The camera security system of claim 1 and further comprising:
a security mode.

8. The camera security system of claim 1 and further comprising:
a torsionally biased spool attached to said strap.

9. The camera security system of claim 1 and further comprising:
a wire formed within said strap.

10. A method of securing a camera comprising:
capturing, at least partially, a parent object with a strap;
connecting said strap to said camera; and
invoking a security mode provided with said camera.

11. The method of claim 10 wherein said connecting said strap to said camera comprises connecting a connector formed in said strap into a receptacle formed in said camera.

12. The method of claim 10 and further comprising:
notifying upon disruption of said connection between said strap and said camera.

13. The method of claim 12 wherein said notifying comprises activating at least one notification device selected from a group of notification devices consisting of:
a speaker, a piezoelectric element, a strobe and a mechanical buzzer.

14. The method of claim 10 and further comprising:
deactivating said security mode.

15. The method of claim 14 wherein said deactivating said security mode comprises pushing at least one button.

16. The method of claim 15 wherein said at least one button is operatively associated with a lock algorithm.

17. A method of manufacturing a camera comprising:
providing a camera housing;
providing a microprocessor within said camera housing; and
associating, operatively, a security system algorithm with said microprocessor.

18. The method of claim 17 wherein said security system algorithm is operatively associated with a receptacle formed within said camera housing.

19. The method of claim 17 and further comprising:
providing a strap.

20. The method of claim 17 wherein said associating said security system algorithm comprises associating firmware with said microprocessor.

21. The method of claim 17 wherein said associating said security system algorithm comprises associating a lock algorithm.

22. A camera comprising:
means for attaching said camera to a parent object; and
means for notifying upon detachment of said camera from said parent object.

23. The camera of claim 22 and further comprising:
means for activating said means for notifying.
